(19) United States
(12) Patent Application Publication
(10) Pub. No.: US 2026/0055006 A1
(43) Pub. Date: Feb. 26, 2026

(54) PROCESS FOR SELECTIVELY CAPTURING CHEMICAL ELEMENTS FROM A POLYMETALLIC SAMPLE

(71) Applicants: MECAWARE SAS, VENISSIEUX (FR); INSTITUT NATIONAL DES SCIENCES APPLIQUEES DE LYON (INSA), VILLEURBANNE (FR); ECOLE SUP CHIMIE PHYS ELECTRONIQ LYON (CPE LYON), VILLEURBANNE (FR); UNIVERSITE CLAUDE BERNARD LYON 1, VILLEURBANNE (FR); CENTRE NATIONAL DE LA RECHERCHE SCIENTIFIQUE, PARIS (FR)

(72) Inventors: JULIEN LECLAIRE, THEIZÉ (FR); MAXIME DUCREUX, LYON (FR)

(21) Appl. No.: 18/874,167

(22) PCT Filed: Jun. 12, 2023
(86) PCT No.: PCT/EP2023/065675

§ 371 Date: Dec. 12, 2024

(30) Foreign Application Priority Data
Jun. 13, 2022 (EP) 22305858.7

(51) Int. Cl. C01G 53/06; C01F 7/02; C01F 17/247; C01G 45/02; C01G 45/05; C01G 51/06; C22B 3/00; C22B 3/28; C22B 21/00; C22B 26/12; C22B 47/00; H01M 10/54

(52) U.S. Cl. CPC C01G 53/06; C01F 7/02; C01F 17/247; C01G 45/02; C01G 45/05; C01G 51/06; C22B 3/282; C22B 21/0023; C22B 23/0461; C22B 26/12; C22B 47/00; H01M 10/54

(57) ABSTRACT

The present invention relates to a process for selectively capturing chemical elements from a polymetallic liquid sample.

### CROSS-REFERENCE TO RELATED APPLICATION

This application is the U.S. national stage application of International Patent Application No. PCT/EP2023/065675, filed Jun. 12, 2023.

### TECHNICAL FIELD

The present invention relates to a process for selectively capturing chemical elements from a polymetallic liquid sample.

### TECHNICAL BACKGROUND

Energy storage has become a global issue and a major challenge. Since the 1980s, the annual world consumption of oil has become greater than the quantities of new deposits discovered. It is therefore necessary to turn to other sources of energy, such as renewable energies, and to develop technologies for the storage of these energies in order to better manage these resources. Efforts to reduce oil consumption are particularly linked to the development of electric vehicles and batteries. While Lithium-ion batteries are now commonly used in computers and mobile phones, there remains some limitations for large-scale applications like electric vehicles. In particular, such applications require high amounts of strategic metals, such as cobalt or rare earth metals, which are expensive. The development of effective and selective recycling processes is therefore crucial in this field.

To date, few methods for capturing and separating strategic metals, such as those contained in batteries, have been developed.

One method is based on liquid-liquid extraction technology between an aqueous phase and an oil fraction using a synthetic surfactant (ACS Sustainable Chem. Eng. 2018, 6, 13611-13627). However, this method is expensive, leads to low yields and is not environmentally compatible.

Another method is based on affinity chromatography. A solid support is chemically grafted by a particular molecule and the solid support is determined according to the nature of the metals to be separated. The metals are selectively adsorbed on the solid support according to the nature of their grafting. The separation is carried out by hydrolysis using a strong acidic or basic solution. This process is effective, however it is very expensive and requires the use of aggressive effluents.

WO 2014/188115 describes a method suitable for the detection, capture and/or selective release of chemical elements chosen from poor metals, alkali metals, alkaline earth metals, actinides and rare earths. This method uses a molecular assembly formed of at least one amine, and at least one aldehyde and/or one imine and/or CO₂, or an adduct formed by bringing an amine and CO₂ into contact, and at least one of these chemical elements. At the end of this process, a precipitate is recovered, and the metal can be recovered from such precipitate. Although this process has undeniable advantages from an economic point of view, it is not optimized for the industrial scale.

WO 2017/191042 describes a similar process optimized for the industrial scale. In such process, organic reagents and metals are brought into contact under special conditions, generating a segmented flow, which allows continuous capture of the metals. However, the metals are captured in the form of an amine carbamate complex, and thus subsequent steps are required to convert said complex into a convenient and directly marketable metal salt. In addition, this process is only applied to the separation of two chemical elements. This is not sufficient for batteries, which may contain up to ten different chemical elements.

Thus, there remains a need to provide an effective process that enables to selectively capture chemical elements from a polymetallic sample, said chemical elements being directly obtained in a convenient form.

### SUMMARY OF THE INVENTION

In this respect, the inventors have developed an effective process that allows to capture chemical elements from a polymetallic liquid sample, by selective precipitations. This process uses combinations of simple reactants, such as CO₂, amines, or copper ions, and can be carried out under mild conditions. In order to optimize the techno-economic features of the process, the latter is advantageously carried out at high concentrations. In addition, the chemical elements to be captured are obtained in a convenient and directly marketable form, typically in the form of a carbonate, hydroxide or oxide salt.

Thus, the present invention relates to a process for capturing three chemical elements M1, M2, M3, and optionally a fourth chemical element M4, contained in a liquid sample, said process comprising the following steps:
a) contacting said liquid sample with at least one amine and optionally CO₂, so as to obtain a first liquid phase, M1 in a solid form, and optionally M2 in a solid form,
b) recovering said M1 in a solid form, and optionally said M2 in a solid form,
c) contacting said first liquid phase with copper ions, so as to obtain a second liquid phase,
d) contacting said second liquid phase with a carbonate and optionally a hydroxide, so as to obtain a third liquid phase, M3 in a solid form, optionally M4 in a solid form, and optionally M2 in a solid form,
e) recovering said M3 in a solid form, optionally said M4 in a solid form, and optionally said M2 in a solid form,
said M2 in a solid form being recovered in step b) and/or step e),
M1 being selected from the group consisting of iron, aluminum, titanium, a rare earth, an actinide, and a combination thereof,
M2 being manganese, and
M3 and M4 being each independently selected from the group consisting of nickel, cobalt, and a combination thereof.

In a particular embodiment, M1 is iron, aluminum, a rare earth chosen from lanthanum and praseodymium, or a combination thereof.

In another particular embodiment, M3 is nickel and M4 is cobalt.

In another particular embodiment:
M1 in a solid form is a carbonate, a hydroxide, an oxide, or a combination thereof, of M1;
M2 in a solid form is a carbonate, a hydroxide, an oxide, or a combination thereof, of M2;
M3 in a solid form is a carbonate, a hydroxide, an oxide, or a combination thereof, of M3; and/or
M4 in a solid form is a carbonate, a hydroxide, an oxide, or a combination thereof, of M4.

In another particular embodiment, the at least one amine to be used in step a) is selected from the group consisting of ethylene diamine (EDA), propane diamine, diethylenetriamine (DETA), triethylenetetramine, tris-(2-aminoethyl)amine, lysine, glycine, 2,3-diaminopropionic acid, 2,4-diaminobutyric acid, and 2,5-diaminopentanoic acid, preferably from ethylene diamine and diethylenetriamine.

In one particular embodiment, M2 in a solid form is recovered in step b).

In a more particular embodiment, the process of the invention is such that:
step a) comprises contacting said liquid sample with at least one amine and optionally CO₂, so as to obtain a first liquid phase, M1 in a solid form, and M2 in a solid form, and
step b) comprises recovering successively said M1 in a solid form and said M2 in a solid form.

In a preferred embodiment, the succession of steps a) and b) comprises:
i) contacting the liquid sample with at least one amine, so as to obtain a liquid phase L0 and M1 in a solid form,
ii) recovering said M1 in a solid form,
iii) contacting said liquid phase L0 with CO₂ and optionally at least one amine, under an inert atmosphere, so as to obtain said first liquid phase and M2 in a solid form, and
iv) recovering M2 in a solid form.

In another preferred embodiment, the succession of steps a) and b) comprises:
i′) contacting the liquid sample with at least one amine and CO₂ under an inert atmosphere, so as to obtain a liquid phase L0′,
ii′) heating said liquid phase L0′ to a temperature T₁ above room temperature, under an inert atmosphere, so as to obtain a liquid phase L0″ and M1 in a solid form,
iii′) recovering said M1 in a solid form,
iv′) heating said liquid phase L0″ to a temperature T₂ above room temperature, under an oxygen-containing atmosphere, so as to obtain said first liquid phase as defined herein and M2 in a solid form, and
v′) recovering M2 in a solid form.

Preferably, the temperatures T₁ and T₂ are each independently comprised between 70° C. and 110° C., more preferably at about 100° C.

Preferably, the succession of steps d) and e) comprises:
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain the third liquid phase and M4 in a solid form, and
δ) recovering said M4 in a solid form.

In a particular embodiment, said reducing agent is a solid metal such as metallic cobalt, metallic iron, or metallic copper, CO₂ or activated carbon.

In another particular embodiment, M2 in a solid form and optionally M4 in a solid form are recovered in step e). In such embodiment, M2, M3 and optionally M4, each in a solid form, are preferably recovered in the form of one single salt, preferably a carbonate, a hydroxide or a combination thereof.

In another particular embodiment, said liquid sample further comprises a chemical element M5, and the process of the invention further comprises, after step e), the following steps:
f) precipitating M5 in a solid form from the third liquid phase, so as to obtain M5 in a solid form and a fourth liquid phase, and
g) recovering M5 in a solid form, preferably by filtration, centrifugation, or reverse osmosis, wherein M5 is copper.

In a particular embodiment, the process of the invention further comprises before step a):
a step of leaching lithium from a solid sample comprising lithium, M1, M2, M3 and optionally M4, so as to obtain leached lithium and a solid sample comprising M1, M2, M3 and optionally M4;
a step of recovering said leached lithium; and
a step of converting said solid sample comprising M1, M2, M3 and optionally M4, into a liquid sample comprising M1, M2, M3 and optionally M4, said liquid sample corresponding to the liquid sample provided in step a) of the process according to the invention.

In another particular embodiment, said liquid sample further comprises lithium and the process of the invention further comprises, after step e) or step g), the following steps:
h) concentrating said third or fourth liquid phase, so as to obtain lithium in a solid form, and
j) recovering lithium in a solid form, preferably by filtration, centrifugation or reverse osmosis.

In a particular embodiment, the contacting steps of the process of the invention are carried out in water.

In another particular embodiment, the recovering steps of the process of the invention are each independently carried out by filtration, centrifugation, or reverse osmosis.

### DETAILED DESCRIPTION OF THE INVENTION

In the present application, the term “about” preceding a value is well-known to the skilled artisan and means that said value may vary to a certain extent depending on the context in which the term is used. If certain uses of this term are not clear to the skilled artisan depending on the context, then “about” means±20%, preferably ±10% of said value.

Unless otherwise indicated, when a range is expressed by means of the expression “comprised between”, the limit values are included within the range described.

The process of the invention allows to capture (or “recover”), and optionally detect, at least three, preferably at least four, for instance four, five, six, or seven chemical elements from a polymetallic liquid sample, typically by selective precipitation. Said chemical elements are each independently obtained in a solid form, in particular in the form of a salt such as a carbonate, a hydroxide, an oxide, or a combination thereof.

The capturing or recovering of the chemical elements of the process according to the invention is typically carried out after observation (or “detection”) of a precipitate after different components and/or reactants have been brought into contact. Advantageously, the detection additionally comprises the comparison of the sample obtained with a similar sample which does not comprise the chemical element and which can be denoted reference sample. Likewise, the detection can additionally comprise the comparison of the sample obtained with a similar sample which comprises the chemical element. The duration of each contacting step of the process of the invention can be suitably adjusted by the skilled artisan, and may in particular be determined by the period of time necessary for the complete formation of a precipitate after contacting the components and/or reactants.

The liquid sample on which the capturing process according to the invention is carried out can be any type of liquid sample comprising the chemical elements M1, M2, M3, and optionally M4, as defined herein. It can be a liquid sample of any origin. For instance, the liquid sample may be originating from a battery, wastes from batteries production, effluents from steel industry or dairy industry, red mud, ores, or fly ash. In a particular embodiment, the liquid sample is a sample originating from a battery, for instance a nickel-metal hydride or Li-ion battery, or a component thereof (such as a battery cathode). More specifically, the liquid sample may be obtained by solubilizing or leaching a solid sample comprising chemical elements M1, M2, M3, and optionally M4, as defined herein, said solid sample being typically from a battery, for instance a nickel-metal hydride or Li-ion battery, or a component thereof (such as a battery cathode). Such a solubilizing or leaching step may be carried out by contacting said solid sample with an aqueous solution comprising an acid, such as nitric acid, hydrochloric acid or sulfuric acid. The solid samples may be of any one of the following formulae: La₂Ni₉CoMn, AlₓFe_{y}Ni_{z}MnCoO with x and y being each independently from 0.1 and 10, and z is an integer from 1 to 8 (preferably 8), LiAl_{w}CuFeNiₖMnCoO with w being from 0.1 and 10 and k is an integer from 1 to 8 (preferably 8), or LiAl_{0.1}Ni_{0.8}Co_{0.1}Mn_{0.1}O.

Preferably, said liquid sample is an aqueous solution comprising the chemical elements M1, M2, M3, and optionally M4, as defined herein. M1, M2, M3 and M4 (when present) in the liquid sample are typically in the form of cations.

The concentration of M1 in the liquid sample is advantageously equal to or less than 0.5 mol/L, for instance between 0.05 and 0.25 mol/L, or between 0.10 and 0.25 mol/L.

The concentration of M2 in the liquid sample is advantageously equal to or less than 0.5 mol/L, for instance between 0.05 and 0.20 mol/L, or between 0.10 and 0.20 mol/L.

The concentration of M3 in the liquid sample is advantageously equal to or less than 0.75 mol/L, for instance between 0.05 and 0.55 mol/L, or between 0.25 and 0.55 mol/L.

The concentration of M4 (when present) in the liquid sample is advantageously equal to or less than 0.5 mol/L, for instance between 0.05 and 0.20 mol/L, or between 0.10 and 0.20 mol/L.

The concentrations of each chemical element in the liquid sample (i.e. their initial concentration) can be determined by titration ICP (Inductively Coupled Plasma spectroscopy).

M1 is a chemical element selected from the group consisting of iron, aluminum, titanium, a rare earth metal, an actinide, and a combination thereof.

As used herein, “actinide” refers to one or more among the following: actinium ⁸⁹Ac, thorium ^{90Th}, protactinium ⁹¹Pa, uranium ⁹²U, neptunium ⁹³Np, plutonium ⁹⁴Pu, americium ⁹⁵Am, curium ⁹⁶Cm, berkelium ⁹⁷Bk, californium ⁹⁸Cf, einsteinium ⁹⁹Es, fermium ¹⁰⁰Fm, mendelevium ¹⁰¹Md, nobelium ¹⁰²No and lawrencium ¹⁰³Lr.

As used herein, “rare earth” (or equivalently “rare earth metal”) refers to one or more among the following: scandium ²¹Sc, yttrium ³⁹Y and the fifteen lanthanide metals. Lanthanide metals denote lanthanum ⁵⁷La, cerium ⁵⁸Ce, praseodymium ⁵⁹Pr, neodymium ⁶⁰Nd, promethium ⁶¹Pm, samarium ⁶²Sm, europium ⁶³Eu, gadolinium ⁶⁴Gd, terbium ⁶⁵Tb, dysprosium ⁶⁶Dy, holmium ⁶⁷Ho, erbium ⁶⁸Er, thulium ⁶⁹Tm, ytterbium ⁷⁰Yb and lutetium ⁷¹Lu. In a particular embodiment, the rare earth metal is lanthanum or praseodymium.

Preferably, M1 is iron, aluminum, a rare earth chosen from lanthanum and praseodymium, or a combination thereof.

M2 is manganese.

M3 and M4 are each independently a chemical element selected from the group consisting of nickel, cobalt, and a combination thereof.

Preferably, M3 is nickel.

Preferably, M4 is cobalt.

“M1 in a solid form” refers to a solid, in particular a solid salt, comprising the chemical element M1. Preferably, “M1 in a solid form” is a carbonate of M1, a hydroxide of M1, an oxide of M1, or a combination thereof. A particular combination is a carbonate-hydroxide of M1.

As used herein, “M2 in a solid form” refers to a solid, in particular a solid salt, comprising the chemical element M2. Preferably, “M2 in a solid form” is a carbonate of M2, a hydroxide of M2, an oxide of M2, or a combination thereof. A particular combination is a carbonate-hydroxide of M2.

As used herein, “M3 in a solid form” refers to a solid, in particular a solid salt, comprising the chemical element M3. Preferably, “M3 in a solid form” is a carbonate of M3, a hydroxide of M3, an oxide of M3, or a combination thereof. A particular combination is a carbonate-hydroxide of M3.

As used herein, “M4 in a solid form” refers to a solid, in particular a solid salt, comprising the chemical element M4. Preferably, “M4 in a solid form” is a carbonate of M4, a hydroxide of M4, an oxide of M4, or a combination thereof. A particular combination is a carbonate-hydroxide of M4.

An amine according to the invention is a compound comprising at least one, preferably one or two, primary or secondary amine groups, and optionally at least one tertiary amine group.

The amine according to the invention can be of general formula (IV) R₂—NH—R₃, in which R₂ is chosen from alkyl, alkenyl, alkynyl, cycloalkyl, cycloalkenyl and cycloalkynyl groups and aromatic groups, the hydrocarbon chain of which is optionally interrupted by at least one heteroatom chosen from N, O and S and which is optionally substituted by at least one substituent, which substituent preferably does not comprise an aldehyde CHO; R₃ is chosen from a hydrogen atom, alkyl, alkenyl, alkynyl, cycloalkyl, cycloalkenyl and cycloalkynyl groups and aromatic groups, the hydrocarbon chain of which is optionally interrupted by at least one heteroatom chosen from N, O and S and which is optionally substituted by at least one substituent. Preferably, the substituents do not independently comprise an aldehyde CHO.

In a particular embodiment, the amine comprises at least 2 amine groups, preferably at least 3, at least 4 or at least 5 amine groups. In particular, the amine is such that R₃ is a hydrogen atom and R₂ is an alkyl group, the hydrocarbon chain of which is preferably interrupted by at least one nitrogen atom, and optionally substituted by one —COOH group. In such embodiment, R₂ may be an alkyl group substituted by at least one NH₂ substituent, preferably substituted by a single NH₂ substituent, more preferably terminated by a single NH₂ substituent. In such embodiment, R₂ is preferably interrupted by at least one N atom, preferably interrupted by 1, 2 or 3 N atoms.

Preferably, an amine according to the invention is chosen from the following compounds:

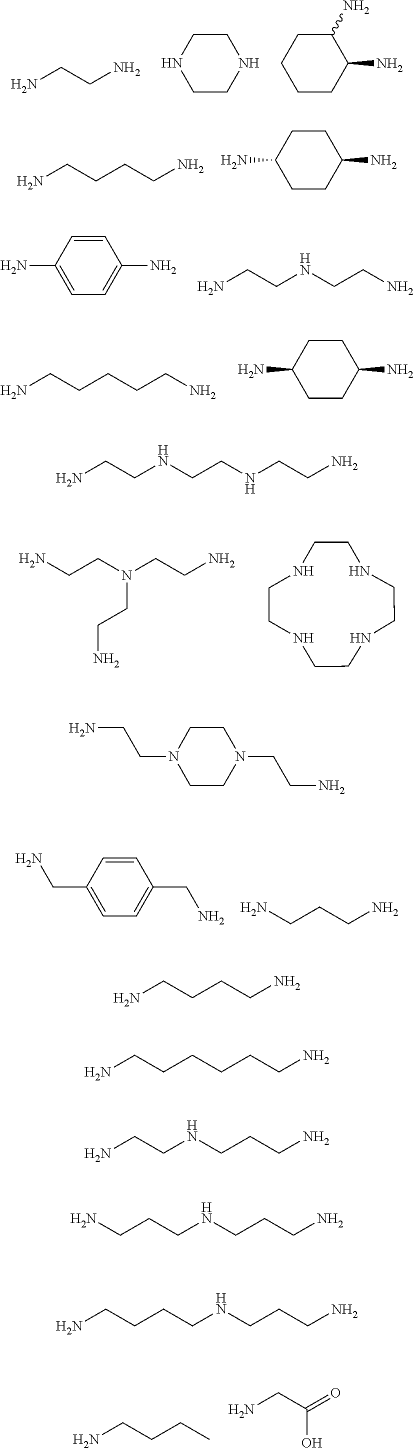

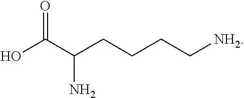

In a particular embodiment, the amine is a basic amino-acid (being preferably non-proteinogenic) such as 2,3-diaminopropionic acid

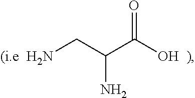

2,4-diaminobutyric acid

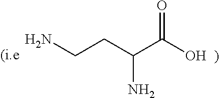

or 2,5-diaminopentanoic acid

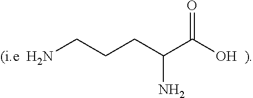

The basic amino-acid may be of formula (IV) as defined above, with R₂ being an alkyl group, preferably comprising from 1 to 6 carbon atoms, substituted by at least one NH₂ substituent and at least one CO₂H substituent, preferably by a single NH₂ substituent and a single CO₂H substituent.

The amine may be an amine from a water-lean solvent, such as N-methylethylenediamine, N,N-dimethylethylenediamine, N,N′-dimethylethylenediamine, N,N,N′,N′-tetramethylethylenediamine or 1,3-propanediamine.

In an embodiment, the amine is selected from the group consisting of glycine, 2,3-diaminopropionic acid, 2,4-diaminobutyric acid, 2,5-diaminopentanoic acid, lysine, ethylene diamine, 1,5-diaminopentane, diethylene triamine, N-(3-aminopropyl) 1,4-butanediamine, N-methylethylenediamine, N,N-dimethylethylenediamine, N,N′-dimethylethylenediamine, N,N,N′,N′-tetramethylethylenediamine and 1,3-propanediamine.

More preferably, the amine is chosen from ethylene diamine

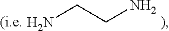

propane diamine

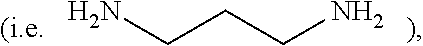

diethylenetriamine (DETA)

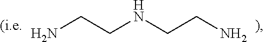

triethylenetetramine

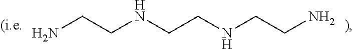

tris-(2 aminoethyl)amine

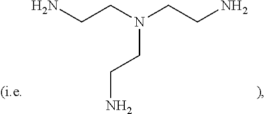

lysine

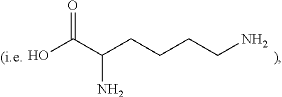

glycine

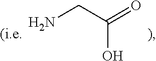

2,3-diaminopropionic acid

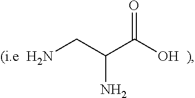

2,4-diaminobutyric acid

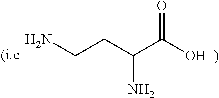

and 2,5-diaminopentanoic acid

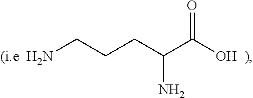

even more preferably from ethylene diamine and diethylenetriamine.

The amine may be either water-miscible or non-water miscible.

The carbon dioxide used in the process of the invention (in particular in steps a), i′) and/or iii) can result from a human activity, of which it represents a waste product; for example, it can originate from combustion flue gases, refinery gas, cement works gas or blast furnace gas.

In step a) of the process of the invention, the liquid sample is contacted with at least one amine and optionally CO₂, so as to obtain a first liquid phase, M1 in a solid form, and optionally M2 in a solid form.

In one particular embodiment, M2 in a solid form is recovered in step b). In such an embodiment:
step a) comprises contacting said liquid sample with at least one amine and optionally CO₂, so as to obtain a first liquid phase, M1 in a solid form, and M2 in a solid form, and
step b) comprises recovering said M1 in a solid form and said M2 in a solid form.

The liquid sample, the at least one amine and optional CO₂ may be contacted in step a), simultaneously or successively. Advantageously, contacting step a) is carried out in water.

More particularly, the liquid sample is typically an aqueous solution, and no additional solvent is used to carry out contacting step a). In such embodiments, the amine is preferably water-miscible.

The concentration in amine in step a) may be comprised between 0.05 M and 15 M, preferably between 0.5 M and 10 M, and more preferably between 2 M and 5 M.

The recovery of M1 in a solid form and M2 in a solid form in step b) is preferably carried out successively, and typically during and/or after contacting the liquid sample, the at least one amine and optional CO₂ in step a).

Advantageously, the recovery of M1 in a solid form and the recovery of said M2 in a solid form, are each independently carried out by filtration, centrifugation, and/or or reverse osmosis.

In a particular embodiment, steps a)-b) of the process of the invention comprise:
i) contacting the liquid sample with at least one amine, so as to obtain a liquid phase L0 and M1 in a solid form,
ii) recovering said M1 in a solid form,
iii) contacting said liquid phase L0 with CO₂ and optionally at least one amine, under an inert atmosphere, so as to obtain said first liquid phase and M2 in a solid form, and
iv) recovering M2 in a solid form.

Advantageously, contacting steps i) and iii) are carried out in water. More particularly, the liquid sample and liquid phase L0 are typically aqueous solutions, and no additional solvent is used to carry out contacting steps i) and iii).

The at least one amine in step i) and the optional at least amine in step iii) may be identical or different, preferably identical. The concentration in amine in step i) (and optionally in step iii)) may be comprised between 0.05 M and 15 M, preferably between 0.5 M and 10 M, and more preferably between 2 M and 5 M.

The amount of amine in step i) may be adjusted to reach a pH that favors the formation (or equivalently “precipitation”) of M1 in a solid form. Such pH is typically about 6.

The amount of CO₂ (and, if present, the amount of amine added) in step iii) may be adjusted to reach a pH that favors the formation (or equivalently “precipitation”) of M2 in a solid form. Such pH is typically about 8.

Contacting step iii) is carried out under an inert atmosphere. As used herein, an “inert atmosphere” refers to an atmosphere substantially deprived of oxygen. The inert atmosphere may in particular be created by substantially replacing the air of the vessel in which the contacting step is carried out with an inert gas. Any suitable inert gas may be used to create the inert atmosphere. Preferably, said inert gas is argon, nitrogen, or a combination thereof, more preferably argon.

Contacting step i) may be carried out under inert atmosphere or under oxygen-containing atmosphere, preferably under inert atmosphere.

Contacting steps i) and iii) are advantageously carried out at room temperature, especially when they are implemented under inert atmosphere.

The term “room temperature” is well-known to the skilled artisan, and typically refers to a temperature comprised between 15° C. and 35° C., preferably between 20° C. and 30° C.

The recovery of M1 in a solid form in step ii) and that of said M2 in a solid form in step iv) are typically carried out by filtration, centrifugation, and/or reverse osmosis.

In steps i) and ii), said M1 in a solid form is preferably a hydroxide or carbonate of M1.

In a particular embodiment, M1 is aluminum, and said M1 in a solid form is an aluminum hydroxide (typically of formula Al(OH)₃) in steps i) and ii).

In steps iii) and iv), said M2 in a solid form is preferably a carbonate of M2 (namely manganese carbonate, typically of formula MnCO₃), a carbonate-hydroxide of M2, or an oxide of M2, more preferably a carbonate of M2.

In another particular embodiment, steps a)-b) of the process of the invention comprise:
i′) contacting the liquid sample with at least one amine and CO₂ under an inert atmosphere, so as to obtain a liquid phase L0′,
ii′) heating said liquid phase L0′ to a temperature T₁ above room temperature under an inert atmosphere, so as to obtain a liquid phase L0″ and M1 in a solid form,
iii′) recovering said M1 in a solid form,
iv′) heating said liquid phase L0″ to a temperature T₂ above room temperature under an oxygen-containing atmosphere, so as to obtain said first liquid phase as defined herein and M2 in a solid form, and
v′) recovering M2 in a solid form.

A particular “oxygen-containing atmosphere” is oxygen (i.e. O₂) or air, preferably air.

Advantageously, steps i′), ii′) and iv′) are carried out in water. More particularly, the liquid sample and liquid phase L0′ are typically aqueous solutions, and no additional solvent is used to carry out steps i′), ii′) and iv′).

Preferably, in step i′), the contacting is carried out as follows: an aqueous solution of amine is contacted with CO₂, typically by bubbling and preferably until pH reaches about 7, to form a reaction mixture. Then, the liquid sample is contacted with said reaction mixture.

The concentration in amine in step i′) may independently be comprised between 0.05 M and 15 M, preferably between 0.5 M and 10 M, and more preferably between 2 M and 5 M.

Preferably, the temperatures T₁ and T₂ are each independently comprised between 70° C. and 110° C., preferably at about 100° C.

The recovery of M1 in a solid form in step iii′) and that of said M2 in a solid form in step iv′) are typically carried out by filtration, centrifugation, or reverse osmosis.

In steps ii′) and iii′), said M1 in a solid form is preferably a hydroxide or carbonate of M1. In a particular embodiment, M1 is aluminum, and said M1 in a solid form is preferably an aluminum hydroxide in steps ii′) and iii′).

In steps iv′) and v′), said M2 in a solid form is preferably an oxide of M2 (namely manganese oxide, typically of formula MnO₂).

In another particular embodiment, steps a)-b) of the process of the invention comprise:
i″) contacting the liquid sample with at least one amine (and optionally CO₂), so as to obtain a liquid phase L and M1 in a solid form,
ii″) recovering said M1 in a solid form,
iii″) precipitating M2 in a solid form from said liquid phase L, so as to obtain said first liquid phase as defined herein and M2 in a solid form, and
iv″) recovering said M2 in a solid form.

The precipitating step iii″) may in particular comprise:
iii″-a) contacting said liquid phase L with CO₂ (and optionally at least one amine) under an inert atmosphere, or
iii″-b) heating said liquid phase L to a temperature T₃ above room temperature under oxygen-containing atmosphere.

Advantageously, step i″) and iii″) are carried out in water. More particularly, the liquid sample and liquid phase L are typically aqueous solutions, and no additional solvent is used to carry out such steps.

Step i″) can be carried out under oxygen-containing atmosphere or inert atmosphere.

The amount of amine in step i″) may be adjusted to reach a pH that favors the formation (or equivalently “precipitation”) of M1 in a solid form. Such pH is typically about 6.

The concentration in amine in step i″) (and optionally in step iii″-a)) may be comprised between 0.05 M and 15 M, preferably between 0.5 M and 10 M, and more preferably between 2M and 5M.

Preferably, the temperature T₃ is comprised between 70° C. and 110° C., preferably it is about 100° C.

The recovery of M1 in a solid form in step ii″) and that of said M2 in a solid form in step iv″) are typically carried out by filtration, centrifugation, or reverse osmosis.

In step i″)-ii″), said M1 in a solid form is preferably a hydroxide or carbonate of M1. In a particular embodiment, M1 is aluminum, and said M1 in a solid form is preferably an aluminum hydroxide.

In step iii″-a), said M2 in a solid form is preferably obtained as a carbonate of M2 (namely manganese carbonate).

In step iii″-b), said M2 in a solid form is preferably obtained as an oxide of M2 (namely manganese oxide).

In a particular embodiment, at least 10%, at least 20%, at least 30%, at least 40%, or at least 50%, preferably at least 60%, at least 70%, at least 80%, at least 90%, at least 95%, or at least 98% of M1 in a solid form are recovered in step b) (or step ii), iii′), or ii″)).

In a particular embodiment, when recovered in step b) (or step iv) or step v′)), at least 10%, at least 20%, at least 30%, at least 40%, or at least 50%, preferably at least 60%, at least 70%, at least 80%, at least 90%, at least 95%, or at least 98% of M2 in a solid form are recovered in step b) (or step iv), step v′), or iv″)).

In a particular embodiment, when recovered in step e), at least 10%, at least 20%, at least 30%, at least 40%, or at least 50%, preferably at least 60%, at least 70%, at least 80%, at least 90%, at least 95%, or at least 98% of M1 in a solid form are recovered in step e).

Unless otherwise indicated, the percentages of Mn in a solid form (with n being 1, 2, 3, 4 or 5) recovered in a step corresponds to the ratio of the molar amount of the chemical element Mn recovered as “Mn in a solid form” to the total molar amount of the chemical element Mn in the initial liquid sample (or equivalently, in the initial solid sample from which the liquid sample is obtained).

In an embodiment of the invention, M2 in a solid form is recovered in step e). In such an embodiment:
step a) comprises contacting said liquid sample with at least one amine and optionally CO₂, so as to obtain a first liquid phase, and M1 in a solid form, and
step b) comprises recovering said M1 in a solid form.

In particular, in such an embodiment, steps a)-b) can comprise steps i)-ii) as described above, steps i′)-iii′) as described above, or steps i″)-ii″) as described above.

As used herein, the “first liquid phase” refers to the liquid phase:
obtained after recovering M1 in a solid form and optionally M2 in a solid form, from the liquid sample; and
implemented in step c) of the process of the invention.

The content of said first liquid phase may vary depending on the conditions under which steps a) and b) are carried out.

In an embodiment where M2 in a solid form is recovered in step b) (or step iv), step v′) or step iv″)), the “first liquid phase” refers to the liquid phase:
obtained after recovering M1 in a solid form and M2 in a solid form, from the liquid sample; and
implemented in step c) of the process of the invention.

In an embodiment where M2 in a solid form is recovered in step e), the “first liquid phase” refers to the liquid phase:
obtained after recovering M1 in a solid form, from the liquid sample; and
implemented in step c) of the process of the invention.

Step c) comprises contacting said first liquid phase with copper ions, so as to obtain a second liquid phase. Advantageously, the copper ions in step c) allow the decomplexation between the chemical element M3 and the amine already present in the first liquid phase.

At least one amine may be used in step c). When said at least one amine is used, the first liquid phase is preferably first contacted with said at least one amine and then copper ions are added to the mixture comprising the first liquid phase and the at least one amine, so as to obtain the second liquid phase. Typically, when at least one amine is already present in the first liquid phase, the optional amine in step c) is not added.

The at least one amine, when used in step c), may be identical to or different from (preferably identical to) the at least one amine used in step a) (or in steps i), iii), i′) or i″)).

The copper ions may be from any suitable source known to the skilled artisan.

Preferably, copper ions are added in step c) in the form of a copper salt, or an aqueous solution comprising such copper salt. According to the present invention, a copper salt refers to an electroneutral compound comprising cationic copper and one or more mono- or poly-atomic, mono- or poly-dentate, organic or inorganic, anionic ligands. The copper salt can be represented by the formula CuₓL_{y} wherein:
L represents a mono- or poly-atomic, mono- or poly-dentate, organic or inorganic, anionic ligand,
x is 1 or 2, preferably 1, and
y is 1, 2, or 3, preferably 1 or 2, more preferably 2.

Examples of mono- or poly-atomic, mono- or poly-dentate, organic or inorganic, anionic ligands include, but are not limited to, sulfonates, such as trifluoromethanesulfonate, methanesulfonate, or toluenesulfonate, halides such as chloride, bromide, or iodide, carboxylates, such as acetate, or trifluoroacetate, ketyl-ketonates such as acetylacetonate, tetramethylheptane-dionate, or hexafluoroacetylacetonate, tetrafluoroborate, pentafluorophosphate, hexafluoro-antimonate, nitrite, nitrate, sulfite, sulfate, chlorate, perchlorate, iodate, periodate, hydroxide, and carbonate. Preferably, L is a chloride.

In a particular embodiment, the ligand L is identical to that of the acid used for the solubilization or leaching of the solid sample into said liquid sample implemented in the process of the invention. For instance, if said acid is hydrochloric acid, then the copper salt is advantageously copper chloride.

The amount of copper ions in step c) is advantageously comprised between 1 and 3 molar equivalents, preferably between 1.5 and 2 equivalents, relative to the amount of M3 (or M4).

Advantageously, step c) is carried out in water. More particularly, the first liquid phase is typically an aqueous solution, and no additional solvent is used to carry out step c).

Advantageously, step c) is carried out at room temperature.

As used herein, the “second liquid phase” refers to the liquid phase:
obtained after contacting said first liquid phase with copper ions (and optionally said at least one amine); and
implemented in step d) of the process of the invention.

Step d) comprises contacting said second liquid phase with a carbonate and optionally a hydroxide, so as to obtain a third liquid phase, M3 in a solid form, and optionally M4 in a solid form and optionally M2 in a solid form.

Step e) comprises recovering said M3 in a solid form, optionally said M4 in a solid form, and optionally said M2 in a solid form.

Advantageously, step d) is carried out in water. More particularly, the second liquid phase is typically an aqueous solution, and no additional solvent is used to carry out step d).

As used herein, “a carbonate” refers to “a carbonate salt”. Preferably, the carbonate is a carbonate of an alkali metal (such as sodium carbonate, potassium carbonate, or lithium carbonate), or of an alkaline-earth metal (such as barium carbonate, calcium carbonate or magnesium carbonate). More preferably, the carbonate is lithium carbonate (i.e. Li₂CO₃) or sodium carbonate (i.e. Na₂CO₃), even more preferably lithium carbonate.

The amount of carbonate in step d) is advantageously comprised between 0.5 and 5 molar equivalents, relative to the amount of M3.

As used herein, “a hydroxide” refers to “a hydroxide salt”. Preferably, the hydroxide is a hydroxide of an alkali metal (such as sodium hydroxide, potassium hydroxide, or lithium hydroxide), or of an alkaline-earth metal (such as barium hydroxide, calcium hydroxide or magnesium hydroxide). More preferably, the hydroxide is lithium hydroxide or sodium hydroxide, even more preferably lithium hydroxide.

When present, the amount of hydroxide in step d) is advantageously comprised between 0.5 and 1 molar equivalents, relative to the amount of M3.

In a particular embodiment, the amount of carbonate is comprised between 1 and 5 molar equivalents relative to the amount of M3, and the amount of hydroxide is comprised between 0.5 and 5 molar equivalents relative to the amount of M3.

In a particular embodiment, the molar ratio of carbonate to hydroxide in step d) is comprised between 0.1 and 10, preferably between 0.5 and 2.

In a particular embodiment, step d) comprises contacting said second liquid phase with an aqueous solution comprising a hydroxide and a carbonate of the same metal, such as sodium or lithium, preferably lithium.

In one particular embodiment, M2 in a solid form is recovered in step b).

In such an embodiment:
step d) comprises contacting said second liquid phase with a carbonate and optionally a hydroxide, so as to obtain a third liquid phase, M3 in a solid form, and optionally M4 in a solid form, and
step e) comprises recovering said M3 in a solid form, and optionally said M4 in a solid form.

Preferably, in such an embodiment:
step d) comprises contacting said second liquid phase with a carbonate and optionally a hydroxide, so as to obtain a third liquid phase, M3 in a solid form, and M4 in a solid form, and
step e) comprises recovering said M3 in a solid form, and said M4 in a solid form.

In a preferred embodiment, M3 in a solid form and M4 in a solid form are recovered successively, and typically during and/or after contacting the second liquid phase, the carbonate and the optional hydroxide in step d).

In a more particular embodiment, steps d)-e) of the process of the invention comprise:
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain the third liquid phase and M4 in a solid form, and
δ) recovering said M4 in a solid form.

Advantageously, steps α) and γ) are carried out in water. More particularly, the second liquid phase and said liquid phase L1 are typically aqueous solutions, and no additional solvent is used to carry out steps α) and γ). Contacting step α) is advantageously carried out at room temperature. Contacting step γ) is advantageously carried out at room temperature or under heating to a temperature T₄ above room temperature, T₄ being preferably comprised between 70° C. and 110° C., more preferably at about 100° C.

The amount of carbonate in step α) is advantageously comprised between 0.1 and 10 molar equivalents, relative to the amount of M4.

When present, the amount of hydroxide in step α) is advantageously comprised between 0.1 and 10 molar equivalents, relative to the amount of M4.

In a particular embodiment, the molar ratio of carbonate to hydroxide in step α) is comprised between 0.1 and 10 preferably between 0.5 and 2.

As used herein, a “reducing agent” refers to any chemical or physical species that is able to reduce (i.e. decrease the oxidation state of) ions of the chemical element M4 contained in the liquid phase L1 in step γ). Advantageously, the use of a reducing agent favors the decomplexation between M4 and the amine.

In a particular embodiment, the reducing agent is a solid metal (i.e. having an oxidation state of 0) such as metallic cobalt (i.e. Co⁰), metallic iron (i.e. Fe⁰), or metallic copper (i.e. Cu⁰), CO₂ or activated carbon.

In a preferred embodiment, the reducing agent is metallic cobalt.

More particularly, M4 is cobalt and the reducing agent is metallic cobalt.

The amount of reducing agent in step γ) is advantageously comprised between 0.5 and 5 molar equivalents, relative to the amount of M4.

In another particular embodiment, the reducing agent is an electron produced by electrochemistry.

In a particular embodiment, step γ) comprises contacting said liquid phase L1 with a reducing agent, copper ions, and optionally a carbonate and/or a hydroxide, so as to obtain the third liquid phase and M4 in a solid form. Advantageously, the copper ions from step c) present in the second liquid phase and/or those added in step 7), in combination with the reducing agent, favor the decomplexation between M4 and the amine, and the formation (or “precipitation”) of M4 in a solid form.

The copper ions are preferably added in the form of a copper salt, or an aqueous solution comprising such copper salt, as described above for step c). Preferably, the copper salt of step c) and the optional copper salt of step γ) are identical.

In steps α) and β), said M3 in a solid form is preferably a hydroxide, carbonate or carbonate-hydroxide of M3. In a particular embodiment, M3 is nickel, and said M3 in a solid form is a carbonate-hydroxide of nickel.

In steps γ) and δ), said M4 in a solid form is preferably a hydroxide, carbonate or carbonate-hydroxide of M4. In a particular embodiment, M4 is cobalt, and said M4 in a solid form is a carbonate-hydroxide of cobalt.

In another particular embodiment, steps d)-e) of the process of the invention comprise:
α′) contacting said second liquid phase with a reducing agent, copper ions, and a carbonate (and optionally a hydroxide), preferably in this given order, so as to obtain the third liquid phase, M3 in a solid form and M4 in a solid form, and
β′) recovering said M3 in a solid form and said M4 in a solid form.

In another particular embodiment, M2 in a solid form is recovered in step e).

In such an embodiment:
step d) comprises contacting said second liquid phase with a carbonate and optionally a hydroxide, so as to obtain a third liquid phase, M2 in a solid form, M3 in a solid form, and optionally M4 in a solid form, and
step e) comprises recovering said M3 in a solid form, said M2 in a solid form and optionally said M4 in a solid form.

Preferably, in such an embodiment:
step d) comprises contacting said second liquid phase with a carbonate and optionally a hydroxide, so as to obtain a third liquid phase, M2 in a solid form, M3 in a solid form, and M4 in a solid form, and
step e) comprises recovering said M3 in a solid form, said M2 in a solid form and said M4 in a solid form.

In such embodiment, the conditions of steps d) and e) (such as the temperature, and the amounts of carbonate and optionally hydroxide) are advantageously similar to those described above. In particular, step d) is advantageously carried out at room temperature or under heating to a temperature T₄ above room temperature, T₄ being preferably comprised between 50° C. and 110° C. The amount of carbonate in step d) is advantageously comprised between 0.5 and 5 molar equivalents, relative to the amount of M3. When present, the amount of hydroxide in step d) is advantageously comprised between 0.5 and 1 molar equivalents, relative to the amount of M3.

M2, M3 and the optional M4, each in a solid form, are advantageously recovered in step e) in the form of one single salt, preferably a carbonate and/or hydroxide. When said single salt is both a carbonate and a hydroxide, the ratio of carbonate group (namely CO₃²⁻) to hydroxide group (namely HO⁻) within said salt can vary depending on the conditions (e.g. pH, amounts of carbonate and hydroxide introduced in step d) or α)) under which the process, and more particularly step d) or α), is carried out. For instance, such ratio (carbonate/hydroxide) may be comprised between 0.1 and 2, for instance between 0.1 and 1 or between 0.5 and 2.

In a particular embodiment, M2 is manganese, M3 is nickel and M4 is cobalt, and M2, M3 and M4, each in a solid form, are recovered in step e) in the form of a carbonate-hydroxide of manganese, nickel and cobalt.

As used herein, the “third liquid phase” refers to the liquid phase obtained after recovering M3 in a solid form and optionally M2 in a solid form, and M4 in a solid form (when recovered), from the second liquid phase.

It is understood that the content of said third liquid phase may vary depending on the conditions under which steps d) and e) are carried out.

In an embodiment where M2 in a solid form is recovered in step b) (or step iv) or step v′)), the “third liquid phase” refers to the liquid phase obtained after recovering M3 in a solid form and M4 in a solid form (when recovered), from the second liquid phase.

In an embodiment where M2 in a solid form is recovered in step e), the “third liquid phase” refers to the liquid phase obtained after recovering M1 in a solid form, M2 in a solid form, and M4 in a solid form (when recovered), from the second liquid phase.

In a particular embodiment, at least 10%, at least 20%, at least 30%, at least 40%, or at least 50%, preferably at least 60%, at least 70%, at least 80%, at least 90%, at least 95%, or at least 98% of M3 in a solid form are recovered in step e) (or step β).

In a particular embodiment, at least 10%, at least 20%, at least 30%, at least 40%, or at least 50%, preferably at least 60%, at least 70%, at least 80%, at least 90%, at least 95%, or at least 98% of M4 in a solid form are recovered in step e) (or step δ).

In addition to M1, M2, M3, and optionally M4, the liquid sample may further comprise copper (hereinafter “M5”). The concentration of M5 (when present) in the liquid sample is advantageously equal to or less than 1 mol/L, for instance between 0.01 and 0.5 mol/L.

When present, M5 can typically be captured (or “recovered”) after step e) of the process of the invention.

In a particular embodiment, the process of the invention further comprises after step e):
f) precipitating M5 in a solid form from the third liquid phase, so as to obtain M5 in a solid form and a fourth liquid phase, and
g) recovering M5 in a solid form, preferably by filtration, centrifugation, or reverse osmosis.

The precipitation of M5 can be carried out by any suitable technique known to skilled artisan, such as by contacting the third liquid phase with a sulfide reagent, or by electrochemistry.

It is understood that the copper ions added in step c), α) and/or γ) can also be captured (or “recovered”) in the above steps f) and g).

In addition to M1, M2, M3, and optionally M4 and/or M5, the liquid sample may further comprise lithium. The concentration of lithium (when present) in the liquid sample is advantageously equal to or less than 1 mol/L, for instance between 0.1 and 1 mol/L, or between 0.5 and 1 mol/L.

The lithium can typically be captured (or “recovered”) after step e) or step g) of the process of the invention.

The lithium can for instance be captured by any suitable technique known to the skilled artisan, for instance by:
contacting the third liquid phase with a hydroxide (for instance LiOH) and CO₂,
concentration,
hot crystallization, and/or
liquid-solid separation followed by recrystallization by CO₂ injection.

In a particular embodiment, the process of the invention further comprises after step e) or step g):
h) concentrating said third or fourth liquid phase, so as to obtain lithium in a solid form, and
j) recovering lithium in a solid form, preferably by filtration, centrifugation, or reverse osmosis.

Preferably, the lithium in a solid form is lithium carbonate.

Alternatively, when the liquid sample is obtained by solubilizing a solid sample comprising lithium and chemical elements M1, M2, M3, optionally M4 (said solid sample being typically from a battery, or a component thereof), the lithium may be recovered before said solubilizing step of the solid sample. Particularly, the process of the invention may comprise before step a):
a step of leaching lithium from a solid sample comprising lithium, M1, M2, M3 and optionally M4, so as to obtain leached lithium and a solid sample comprising M1, M2, M3 and optionally M4;
a step of recovering said leached lithium; and
a step of converting (typically, solubilizing using an aqueous solution comprising an acid such as those mentioned above) said solid sample comprising M1, M2, M3 and optionally M4, into said liquid sample comprising M1, M2, M3 and optionally M4.

The leaching step may typically comprise contacting the solid sample comprising lithium, M1, M2, M3 and optionally M4, with a leaching solution such as water (e.g. pure water) or an aqueous solution comprising at least one amine and CO₂. The leaching solution may further comprise additives such as a reducing agent (e.g. a solid metal (i.e. having an oxidation state of 0) such as metallic cobalt (i.e. Co⁰), metallic iron (i.e. Fe⁰), or metallic copper (i.e. Cu⁰), CO₂ or activated carbon).

The leached lithium is typically obtained in the form of lithium carbonate, lithium carbamate, or a mixture thereof.

The process of the invention may further comprise steps for recycling some reactants used therein, in particular:
a step of recycling the at least one amine from steps a), i), iii), i′) and/or c), and/or
a step of recycling the copper ions from steps c), α) and/or γ).

As used herein, the term “recycling of a reactant” refers to the recovery of the reactant and its reuse, typically in a subsequent step of the same process of the invention or in a different process of the invention. For instance, an amine from step a) can be recycled to be reused in step a) of a different process of the invention.

Such recycling steps are usually carried out after the step in which the reactant is used, or at the end of the process of the invention, for instance after step e) or g). Said at least one amine is usually in its acidic form at the end of the process. Said at least one amine can be recycled by using any suitable base (such as a hydroxide) or basic ion-exchange resin. Copper ions can be recycled by striping or precipitating a copper salt CuₓL_{y} as defined above.

In one particular embodiment, M2 in a solid form is recovered in step b). In such an embodiment, the process of the invention comprises the following steps:
a) contacting said liquid sample with at least one amine and optionally CO₂, so as to obtain a first liquid phase, M1 in a solid form, and M2 in a solid form,
b) recovering successively said M1 in a solid form and said M2 in a solid form,
c) contacting said first liquid phase with copper ions, so as to obtain a second liquid phase,
d) contacting said second liquid phase with a carbonate and optionally a hydroxide, so as to obtain a third liquid phase, M3 in a solid form, optionally M4 in a solid form, and
e) recovering successively said M3 in a solid form, optionally said M4 in a solid form.

Preferably, in such an embodiment, the process of the invention comprises the following steps:
a) contacting said liquid sample with at least one amine and optionally CO₂, so as to obtain a first liquid phase, M1 in a solid form, and M2 in a solid form,
b) recovering successively said M1 in a solid form and said M2 in a solid form,
c) contacting said first liquid phase with copper ions, so as to obtain a second liquid phase,
d) contacting said second liquid phase with a carbonate and optionally a hydroxide, so as to obtain a third liquid phase, M3 in a solid form and M4 in a solid form, and
e) recovering successively said M3 in a solid form and said M4 in a solid form.

In a preferred embodiment, the process of the invention comprises the following steps:
i) contacting the liquid sample with at least one amine, so as to obtain a liquid phase L0 and M1 in a solid form,
ii) recovering said M1 in a solid form,
iii) contacting said liquid phase L0 with CO₂ and optionally at least one amine, under an inert atmosphere, so as to obtain a first liquid phase and M2 in a solid form,
iv) recovering M2 in a solid form,
c) contacting said first liquid phase with copper ions, so as to obtain a second liquid phase,
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain a third liquid phase and M4 in a solid form, and
δ) recovering said M4 in a solid form.

In another preferred embodiment, the process of the invention comprises the following steps:
i′) contacting the liquid sample with at least one amine and CO₂ under an inert atmosphere, so as to obtain a liquid phase L0′,
ii′) heating said liquid phase L0′ to a temperature T₁ above room temperature, under an inert atmosphere, so as to obtain a liquid phase L0″ and M1 in a solid form,
iii′) recovering said M1 in a solid form,
iv′) heating said liquid phase L0″ to a temperature T₂ above room temperature, under an oxygen-containing atmosphere (such as air), so as to obtain a first liquid phase and M2 in a solid form,
v′) recovering M2 in a solid form,
c) contacting said first liquid phase with copper ions, so as to obtain a second liquid phase,
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain a third liquid phase and M4 in a solid form, and
δ) recovering said M4 in a solid form.

In another preferred embodiment, the process of the invention comprises the following steps:
i″) contacting the liquid sample with at least one amine (and optionally CO₂), so as to obtain a liquid phase L and M1 in a solid form,
ii″) recovering said M1 in a solid form,
iii″) precipitating M2 in a solid form from said liquid phase L, so as to obtain said first liquid phase as defined herein and M2 in a solid form,
iv″) recovering said M2 in a solid form,
c) contacting said first liquid phase with copper ions, so as to obtain a second liquid phase,
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain a third liquid phase and M4 in a solid form, and
δ) recovering said M4 in a solid form.

In another particular embodiment, M2 in a solid form is recovered in step e). In such an embodiment, the process of the invention comprises the following steps:
a) contacting said liquid sample with at least one amine and optionally CO₂, so as to obtain a first liquid phase, and M1 in a solid form,
b) recovering said M1 in a solid form,
c) contacting said first liquid phase with copper ions, so as to obtain a second liquid phase,
d) contacting said second liquid phase with a carbonate and optionally a hydroxide, so as to obtain a third liquid phase, M2 in a solid form, M3 in a solid form, and optionally M4 in a solid form, and
e) recovering said M3 in a solid form, said M2 in a solid form and optionally said M4 in a solid form.

Preferably, in such an embodiment, the process of the invention comprises the following steps:
a) contacting said liquid sample with at least one amine and optionally CO₂, so as to obtain a first liquid phase and M1 in a solid form,
b) recovering said M1 in a solid form,
c) contacting said first liquid phase with copper ions, so as to obtain a second liquid phase,
d) contacting said second liquid phase with a carbonate and optionally a hydroxide, so as to obtain a third liquid phase, M2 in a solid form, M3 in a solid form, and M4 in a solid form, and
e) recovering said M2 in a solid form, said M3 in a solid form and said M4 in a solid form.

In the above embodiments, it is preferred that:
M1 is aluminum, iron, lanthanum, praseodymium, or a combination thereof, preferably aluminum,
M3 is nickel, and
M4 is cobalt.

The steps of a process according to the invention as described herein can be implemented in the given order or in a different order, preferably in the given order. Intermediate steps may be comprised between any steps of a process of the invention, as described herein.

The invention will also be described in further detail in the following examples, which are not intended to limit the scope of this invention, as defined by the attached claims.

### EXAMPLES

### Example 1. Proof of Concept of the Nickel Cobalt Separation (M3 or M4)

Preliminary tests were carried out on nickel and cobalt complexes with ethylenediamine. The solutions were prepared according to the following protocols:

### Nickel Carbonate (NiCO₃)

Ni(en)₃²⁺ complex solution: 6.480 g of nickel chloride (50 mmol) were placed in a 50 mL volumetric flask. 30 mL of distilled water were added to the flask and the mixture was shaken until complete dissolution of nickel chloride, allowing the formation of a dark green solution. 9.015 g of ethylenediamine (150 mmol, 3 eq) were added dropwise to the mixture, allowing the formation of a dark purple solution. The mixture was brought back to room temperature, and the flask was completed with distilled water.

CuCl₂ solution: 13.638 g of copper chloride dihydrate were placed in 20 mL volumetric flask completed with distilled water. The mixture was shaken until complete dissolution of copper chloride, allowing the formation of a dark green solution.

Na₂CO₃ solution: 10.599 g of sodium carbonate were placed in a 50 mL volumetric flask completed with distilled water. The mixture was shaken until complete dissolution of sodium carbonate, allowing the formation of limpid colorless solution.

NiCO₃ precipitation: 2 mL of Ni(en)₃²⁺ complex (2 mmol) were added to a 10 mL centrifuging tube. 1.4 mL of distilled water were added to the vial and the mixture was shaken. 0.6 mL of copper chloride solution (2.4 mmol, 1.2 eq per nickel) were added to the mixture. The vial was shaken and left at room temperature for 1 hour. 1 mL of Na₂CO₃ solution (2 mmol, 1 eq per nickel) were added to the vial, and the vial was shaken vigorously. The vial was then left at room temperature for 1 hour. The solution was centrifuged, the supernatant was collected and the precipitate was washed 3 times with 7 mL of distilled water. The solid was dried by lyophilization for 24 hours. 155.0 mg of fine blue powder was obtained and analyzed by ICP-OES, giving a precipitation yield of 52% in nickel and a purity of 91%.

### Alternative Nickel Carbonate (NiCO₃) Precipitation

Ni(en)₃²⁺ complex solution: 1.2960 g of nickel chloride (10 mmol) were placed in a 20 mL volumetric flask. 10 mL of distilled water were added to the flask and the mixture was shaken until complete dissolution of nickel chloride, allowing the formation of a dark green solution. 1.803 g of ethylenediamine (30 mmol, 3 eq) were added dropwise to the mixture, allowing the formation of a dark purple solution. The mixture was brought back to room temperature, and the flask was completed with distilled water.

CuCl₂ solution: 3.4096 g of copper chloride dihydrate (20 mmol) were placed in 10 mL volumetric flask completed with distilled water. The mixture was shaken until complete dissolution of copper chloride, allowing the formation of a dark green solution.

NaOH/Na₂CO₃ solution: 0.2 g of sodium hydroxide (5 mmol) and 1.0599 g of sodium carbonate (10 mmol) were placed in a 50 mL volumetric flask completed with distilled water. The mixture was shaken until complete dissolution of sodium hydroxide and sodium carbonate, allowing the formation of limpid colorless solution.

NiCO₃ precipitation: The NaOH/Na₂CO₃ solution was placed in a 250 mL beaker and 20 mL of distilled water were added to the solution. The solutions of Ni(en)₃²⁺ and copper chloride were combined in a 100 mL beaker and left under agitation for 2 hours. After 2 hours, the mixture was filtered on a 0.22 μm membrane and added dropwise over the course of 20 min to the solution of sodium hydroxide and sodium carbonate, under agitation. The solution was left under agitation for 16 hours. The solution was then filtered and washed 3 times with 20 mL of distilled water. The solid obtained was dried at 70° C. for 5 hours. 1.35 g of blue powder was obtained and analyzed by ICP-OES, giving a precipitation yield of 91% in nickel and a purity of 81%.

### Cobalt Carbonate (CoCO₃)

Co(en)₃³⁺ complex solution: 11.897 g of cobalt chloride hexahydrate (50 mmol) were placed in a 50 mL volumetric flask. 30 mL of distilled water were added to the flask and the mixture was shaken until complete dissolution of cobalt chloride, allowing the formation of a dark red solution. 9.015 g of ethylenediamine (150 mmol, 3 eq) were added dropwise to the mixture, allowing the formation of an orange solution. The mixture was brought back to room temperature, and the flask was completed with distilled water. The mixture was placed under an air flux (flowrate: 100 mL/min) and a CO₂ flux (100 mL/min) for 6 hours at 60° C. The solution goes first from orange to dark brown (showing the formation of peroxo complexes), then from dark brown to dark red (formation of tris ethylenediamine cobalt (III)).

CuCl₂ solution: 13.638 g of copper chloride dihydrate was placed in 20 mL volumetric flask completed with distilled water. The mixture was shaken until complete dissolution of copper chloride, yielding a dark green solution.

Na₂CO₃ solution: 10.599 g of sodium carbonate were placed in a 50 mL volumetric flask completed with distilled water. The mixture was shaken until complete dissolution of sodium carbonate, allowing the formation of limpid colorless solution.

CoCO₃ precipitation: 0.75 mL of Co(en)₃³⁺ solution (0.75 mmol) were placed in a 10 mL centrifugeable vial. 2.7 mL of distilled water, as well as 3.3 mg of cobalt 0 powder (0.375 mol, 0.5 eq per initial cobalt) and 68 mg of ethylenediamine (1.125 mmol, 3 eq per cobalt 0) were added to the vial. The vial was put under inert atmosphere, capped with a septum and the mixture was put under magnetic agitation for 24 hours at 60° C. 0.420 mL of CuCl₂ solution (1.68 mmol, 1,5 eq per total cobalt) were added to the mixture under inert atmosphere. The vial was shaken and left at room temperature for one hour. 1.125 mL of Na₂CO₃ (2.225 mmol, 2 eq per total cobalt) were added to the vial under inert atmosphere, then the vial was shaken vigorously. The vial was then left at room temperature for one hour. The solution was centrifuged, the supernatant was collected and the precipitate was washed 3 times with 7 mL of distilled water. The solid was dried by lyophilization for 24 hours. 41.2 mg of fine purple powder was obtained and analyzed by UV-visible spectrometry, showing a precipitation yield of 87% and a purity of 96.7%.

In the following experiments, solutions were added in the following order: 1-Solution of the metallic complex, 2-Solution of sodium carbonate, 3-Solution of copper chloride.

Furthermore, the concentration of other species was chosen in order to have the following stoichiometry: 3 equivalents of ethylenediamine per mole of metal, 2 equivalent of sodium carbonate per mole of metal, 1.5 equivalent of copper chloride per mole of metal. In this case, the analysis was conducted by UV-visible spectrometry, after calibration.

TABLE 1
Experimental conditions for the preliminary
tests on nickel and cobalt

| | C_{NiCl2} | C_{CoCl2} | C_{ethylenediamine} | C_{Na2CO3} | C_{CuCl2} |
|---|---|---|---|---|---|
| | (mol/L) | (mol/L) | (mol/L) | (mol/L) | (mol/L) |
| Experiment 1 | 0.25 | / | 0.75 | 0.5 | 0.375 |
| Experiment 2 | / | 0.15 | 0.45 | 0.3 | 0.225 |

The results obtained are summarized in table 2. The precipitation yield corresponds to the ratio between the metal's number of moles in the precipitate and the metal's number of moles introduced initially. The purity corresponds to ratio between the number of moles of targeted metal (nickel or cobalt) and the total number of moles of metals (nickel or cobalt and copper) in the precipitate.

TABLE 2
Precipitation yields and purities obtained for preliminary
precipitation tests of nickel and cobalt carbonates

| | Precipitation yield (%) | Purity (%) |
|---|---|---|
| Nickel precipitation | 84.5 | 85 |
| Cobalt precipitation | 87 | 96.7 |

Different solutions comprising nickel ions, copper ions and ethylene diamine have been prepared, with the concentration of nickel varying from 0.1M to 0.4M, and a stoichiometry of copper (vs nickel) ranging from 0.8 to 2 equivalents.

Tables 3 and 4 show that good yields and purities were obtained.

TABLE 3
Precipitation yields in nickel depending on the initial concentration
and the number of equivalent in copper added

Ni; [Ni]

| Eq Cu | 0.1 | 0.2 | 0.3 | 0.4 |
|---|---|---|---|---|
| 0.8 | 18% | 20% | 22% | 18% |
| 1.2 | 43% | 50% | 50% | 52% |
| 1.6 | 42% | 46% | 44% | 54% |
| 2 | 22% | 26% | 27% | 31% |

TABLE 4
Purity in nickel depending on the concentration in nickel [Ni]
in mol · L⁻¹ and the Cu/Ni stoichiometry

Ni; [Ni]

| Eq Cu | 0.1 | 0.2 | 0.3 | 0.4 |
|---|---|---|---|---|
| 0.8 | 84% | 92% | 79% | 91% |
| 1.2 | 89% | 92% | 91% | 91% |
| 1.6 | 70% | 75% | 74% | 76% |
| 2 | 35% | 37% | 42% | 49% |

The preliminary tests demonstrate that:
nickel in solution with amine can be precipitated in good yields and purities, by using a combination of copper ions and carbonate,
cobalt in solution with amine can be precipitated in good yields and purities, by using a combination of a reducing agent, copper ions and carbonate.

### Example 2. Process According to the Invention

Step 0. Preparation of a Pr₂Ni₉MnCo Polymetallic Solution

3.0320 g of Pr₂(CO₃)₃·8H₂O were placed in a 50 mL volumetric flask. 15 mL of distilled water, as well as 2.4731 g of 37% hydrochloric acid were added to the flask. The solution was mixed until complete dissolution of the praseodymium carbonate. 1.1900 g of CoCl₂·6H₂O, 6.4786 g of NiCl₂ and 0.9899 g of MnCl₂·4H₂O were added to the solution, with 30 mL of distilled water, and the mixture was shaken until complete dissolution of solids. The flask was completed with distilled water.

Step 1 (Steps i′)-ii′)-iii′)). Precipitation of Praseodymium Carbonate Pr₂(CO₃)₃

1.0301 g of diethylenetriamine (DETA) were placed in a 10 mL centrifuging vial containing 1.5 mL of distilled water. CO₂ was fluxed in the solution at a flowrate of 80 mg/min for 1 hour, until the pH reaches 7. 2.5 mL of the polymetallic solution prepared in the above step 0) were added dropwise to the vial, leading to an important degassing. The solution was placed under inert atmosphere and heated to 100° C. for 1 hour. The vial was brought back to room temperature, then centrifuged and the supernatant was collected. The obtained solid was washed 3 times with 8 mL of distilled water, then dried for 24 hours by lyophilization. 0.1536 g of bright green solid was obtained and analyzed by ICP, showing a precipitation yield of 87.3% and a purity of 67.2%.

Step 2 (Steps iv′)-v′)). Precipitation of Manganese Oxides

The supernatant and washing waters from the above step 1) were placed in a 50 mL vial. The vial was placed in a water bath under an air flux and heated to 100° C. to evaporate the excess water. Once the volume in vial reaches about 7.5 mL, the vial was centrifuged and washed 3 times with 3 mL of distilled water, then the solid was dried for 24 hours by lyophilization. 13.6 mg of black solid were collected and analyzed by ICP, showing a precipitation yield of 22.2% and a purity of 73.9%.

Step 3 (Steps c)-α)-β)). Precipitation of Nickel Carbonate NiCO₃

The supernatant and washing waters from the above step 2) were placed in a 50 mL vial, to give a 22.5 mL solution at pH 10.5. 1.0713 g of CuCl₂·2H₂O were dissolved in 2.5 mL of distilled water. The solution was added dropwise to the vial under strong magnetic agitation. 1.19 g of Na₂CO₃ were dissolved in 4 mL of distilled water, then the solution was added dropwise to the vial. The mixture was centrifuged and the supernatant was collected. The obtained solid was washed 4 times with 8 mL of distilled water, then dried by lyophilization for 24 hours. 0.1437 g of turquoise powder were obtained and analyzed by ICP, showing a precipitation yield of 39% and a purity of 72.6%.

### Step 4 (Steps γ)-δ)). Precipitation of Cobalt Carbonate CoCO₃

The supernatant and washing waters from the above step 3) were placed in a 50 mL vial. The solution was concentrated in a water bath at 100° C. until the volume reaches 20 mL. 11.6 mg of cobalt 0 powder were added to the solution, then the vial was capped with a septum and left under magnetic agitation for 48 hours. 0.546 g of CuCl₂·2H₂O were dissolved in 1 mL of distilled water, then added dropwise to the mixture. The mixture was centrifuged and the supernatant was collected. The obtained solid was washed 4 times with 8 mL of distilled water, then dried by lyophilization for 24 hours. 0.3642 g of blue powder were obtained and analyzed by ICP, showing a precipitation yield of 28.6% and a purity of 3.9%.

The precipitation yields, as well as the proportion of each metal in each precipitate are presented respectively in Tables 5 and 6.

TABLE 5
Precipitation yield (%) in each metal for each separation step

| Metal | Step 1 | Step 2 | Step 3 | Step 4 | Total |
|---|---|---|---|---|---|
| Cobalt | 9.9 | 1.1 | 3.0 | 28.6 | 42.6 |
| Copper | 0 | 0 | 2.9 | 22.1 | 25.0 |
| Manganese | 52.9 | 22.2 | 8.3 | 2.4 | 85.8 |
| Nickel | 1.5 | 0.5 | 39.0 | 38.0 | 79.0 |
| Praseodymium | 87.3 | 0.6 | 10.7 | 12.0 | 110.6 |

TABLE 6
Proportion (molar %) in each metal for each precipitation step

| Metal | Step 1 | Step 2 | Step 3 | Step 4 |
|---|---|---|---|---|
| Cobalt | 6.8 | 6.4 | 1.0 | 3.9 |
| Copper | 0 | 0 | 20.9 | 64.7 |
| Manganese | 20.3 | 73.9 | 1.5 | 0.2 |
| Nickel | 5.7 | 15.6 | 72.6 | 29.3 |
| Praseodymium | 67.2 | 4.1 | 4.0 | 1.9 |

### Example 3. Process According to the Invention

The following protocol concerns a black mass containing the proportions of metals indicated in Table 7.

TABLE 7

| | Li | Ni | Co | Al | Mn |
|---|---|---|---|---|---|
| M (g/mol) | 6.9395 | 58.6934 | 58.9331 | 26.981 | 54.938 |
| wt % | 5.62% | 26.52% | 8.87% | 5.16% | 8.41% |
| n (mol/g) | 0.00809568 | 0.00451872 | 0.001505642 | 0.00191399 | 0.00153068 |

The protocol was established for a 100 mL solution and a concentration of 0.5M of Nickel in solution. The Nickel concentration decreases after each step, because solutions were added, thereby inducing a dilution. The Nickel concentration reaches a minimum of 0.3M during the step of nickel carbonate precipitation.

### Step 0. Dissolution of the Black Mass

11.1 g of black mass were placed in a 250 mL flask. 75 g of distilled water were added to the flask and the solution was placed under stirring. The assembly was equipped with a soda trap, in order to capture Cl₂. 31.6 g of HCl 37% (2 equiv. per Ni, Mn and Co+1 equiv. per Li+3 equiv. per Al) were added dropwise to the mixture, under a stream of nitrogen. Once the addition was complete, the mixture was heated at 80° C. for 2 hours. The mixture was brought back to room temperature and then filtered through a filter (porosity <2 μm).

The concentrations of the following metals in the liquid sample obtained after step 0, as determined by ICP titration, were:
Lithium: 0.89 mol/L;
Nickel: 0.5 mol/L;
Manganese: 0.17 mol/L;
Cobalt: 0.17 mol/L;
Aluminum: 0.21 mol/L.
   Step 1 (Steps i)-ii)). Precipitation of Aluminum Hydroxide Al(OH)₃

The filtrate obtained in the above step 0) was placed in a 250 mL flask, then an amount of ethylenediamine was added dropwise until a pH of 6 was reached. The solution was filtered through a filter (porosity <2 μm) and the precipitate was washed twice with 5 mL of distilled water.

Step 2 (Steps iii)-iv)). Precipitation of Manganese Carbonate MnCO₃

The filtrate obtained in the above step 1) was placed in a 250 mL flask, then an amount of degassed ethylenediamine (the total amount of ethylenediamine added in steps 1) and 2) being equal to 16.07 g) was added dropwise to the mixture, under nitrogen flow. The formation of a white precipitate (brown, if the inerting was not complete) was observed. A CO₂ bubbling was then carried out, until the re-solubilization of the precipitate (pH≈7.4). The solution was then left under stirring for 1 hour, allowing the formation of a white precipitate. The mixture was filtered through a filter (porosity <2 μm), and the solid was washed twice with 5 mL of distilled water.

Step 3 (Steps c)-α)-β)). Precipitation of Nickel Carbonate NiCO₃

A solution containing 14.6 g of anhydrous CuCl₂ in 20 mL of distilled water was prepared. The filtrate obtained in the above step 2) was placed in a 250 mL flask, and the CuCl₂ solution was added to the flask. The mixture was left under stirring for 10 min. A solution containing 5.31 g of Na₂CO₃ and 1 g of NaOH in 20 mL of distilled water was prepared and added dropwise to the mixture. The resulting mixture was left under stirring for 3 hours. The mixture was then filtered through a filter (porosity <2 μm) and the solid was washed twice with 5 mL of distilled water.

### Step 4 (Steps γ)-δ)). Precipitation of Cobalt Carbonate CoCO₃

The filtrate obtained in the above step 3) was placed in a 250 mL flask and the flask was inerted with nitrogen. 0.492 g of metallic cobalt powder were added to the flask, then the mixture was left under stirring at 60° C., for 48 hours. After 48 hours, the residual cobalt powder was filtered under an inert atmosphere, then a solution containing 5.05 g of anhydrous CuCl₂ in 10 mL of distilled water was added to the mixture. The solution was left under stirring for 15 min, then a solution containing 2.65 g of Na₂CO₃ and 0.5 g of NaOH in 10 mL of water was added dropwise to the metal solution. The mixture was left stirring for 3 hours, then the solid was filtered through a filter (porosity <2 μm) and washed twice with 5 mL of distilled water.

### Example 4. Process According to the Invention

### Step 0. Dissolution of the Black Mass

11.11 g of black mass were placed in a 250 mL flask. 40 g of distilled water were added to the flask and the solution was placed under stirring. The assembly was equipped with a soda trap, so as to capture Cl₂. 34.9 g of 37% HCl (2 eq per Ni, Mn and Co+1 eq per Li+3 eq per Al) were added dropwise to the mixture, under nitrogen flow. Once the addition was complete, the mixture was heated at 80° C. for 8 hours The mixture was brought to room temperature then filtered through a 2 μm filter. The flask was rinsed with 10 mL of water. The solid was washed with a dilute sodium hydroxide solution to capture residual Cl₂.

The results of the dissolution are shown in Table 8.

TABLE 8

| | n initial (mol) | n leached (mol) | Yield (%) |
|---|---|---|---|
| Li | 8.98 × 10⁻² | 7.46 × 10⁻² | 83.0% |
| Ni | 4.92 × 10⁻² | 4.14 × 10⁻² | 84.1% |
| Co | 1.59 × 10⁻² | 1.27 × 10⁻² | 79.8% |
| Al | 1.98 × 10⁻² | 2.46 × 10⁻² | 124.6% |
| Fe | 3.85 × 10⁻⁴ | 3.50 × 10⁻⁴ | 91.0% |
| Mn | 1.62 × 10⁻² | 1.30 × 10⁻² | 80.4% |

Step 1 (Steps i)-ii)). Precipitation of Aluminum Hydroxide Al(OH)₃

The filtrate obtained during the previous step was placed in a 250 mL flask and 20 mL of water were added, then 8 ml of EDA (99%) was added until the pH was 6.1 and a solid (pink/red) formed. The solid was filtered (slow filtration), and washed with 2×5 mL of water. The pH of the filtered solution was 6.2.
→99% of aluminum was recovered in step 1)
   Step 2 (Steps iii)-iv)). Precipitation of Manganese Carbonate MnCO₃

The solution was degassed with argon for one hour, then 5 mL EDA (99%) was added to reach a pH of 9. CO₂ bubbling was carried out for 2 hours and a brown solid formed. The solution was filtered (slow filtration) and the solid was washed with 200 mL of H₂O, the solution was evaporated to obtain a mass of solution of 121 g.
→Manganese was efficiently recovered in step 2)
   Step 3 (Steps c)-α)-β)). Precipitation of Nickel Carbonate NiCO₃

A solution containing 15.8 g of CuCl₂·2H₂O in 20 mL of distilled water was prepared. The filtrate obtained during the previous step was placed in a 250 mL flask, and the copper chloride solution was added to the flask. A blue solid and a foam form, after heating to remove the foam (CO₂), the solution was filtered to remove the solid formed. A solution containing 5.31 g of Na₂CO₃ and 1.050 g of NaOH in 20 mL of distilled water was prepared and added to the metallic mixture. The mixture was then filtered through a 1 μm filter (slow filtration) and the solid was washed with twice 5 mL of distilled water.
→60% of nickel was recovered in step 3)

### Step 4 (Steps γ)-δ)). Precipitation of Cobalt Carbonate CoCO₃

The filtrate obtained during the previous step was placed in a 250 mL flask and the flask was inerted with nitrogen. 0.75 g of metallic cobalt powder were added to the flask after grinding, then the mixture was left under stirring at 60° C. for 36 h. After 36 hours, the solid formed was filtered under an inert atmosphere (argon bubbling in a funnel above the vacuum flask).

A solution containing 6.41 g of CuCl₂·2H₂O in 20 mL of distilled water was added to the vacuum flask to limit the possibilities of oxidation of the cobalt complex.

The formation of a solid was observed, it was filtered on 1 μm then a solution containing 2.67 g of Na₂CO₃ and 0.57 g of NaOH in 20 mL of water was added to the metallic solution. The solid was filtered through a filter (porosity <2 μm) and washed twice with 5 mL of distilled water.
→39% of cobalt was recovered in step 4)

### Example 5. Precipitation of Aluminum Hydroxide (Steps i)-ii) of the Process According to the Invention)

### Step 0. Dissolution of the Black Mass

22.64 g of black mass (LiAl_{0.1}Ni_{0.8}Co_{0.1}Mn_{0.1}O) were placed in a 250 mL flask. 80 mL of distilled water were added to the flask and the solution was placed under stirring. The assembly was equipped with a soda trap, in order to capture Cl₂. 60 mL of HCl 37% were added dropwise to the mixture, under a stream of nitrogen. Once the addition was complete, the mixture was heated under reflux for 24 hours. The mixture was brought back to room temperature, then filtered through a filter (porosity <2 μm), and washed with 220 mL of water.

The results of the dissolution are shown in Table 9.

TABLE 9

| | Li | Ni | Co | Al | Mn |
|---|---|---|---|---|---|
| Mol | 0.183 | 0.1 | 0.032 | 0.04 | 0.033 |
| Mol % | 43.4 | 28 | 8.2 | 12 | 8.3 |
| Yield (%) | 84 | 99 | 90 | 100 | 88.8 |

Step 1 (Steps i)-ii)). Precipitation of Aluminum Hydroxide Al(OH)₃

The filtrate obtained during the previous step (concentration: 1.07 M) was placed in a flask, and EDA (5 M) was added until the pH 6 was obtained. The solid was filtered, and washed with water.

No aluminum was detected in the filtrate. The metal composition of the solid is shown in Table 10.

TABLE 10

| | Li | Ni | Co | Al | Mn |
|---|---|---|---|---|---|
| Mol % | 0 | 0.8 | 0.7 | 98.5 | 0 |
| Yield (%) | 0 | 1.08 | 1.45 | 95 | 0 |

1-15. (canceled)

16. A process for capturing chemical elements M1, M2, M3, and optionally M4, contained in a liquid sample, said process comprising the following steps:
a) contacting said liquid sample with at least one amine and optionally CO₂, so as to obtain a first liquid phase, M1 in a solid form, and optionally M2 in a solid form,
b) recovering said M1 in a solid form, and optionally said M2 in a solid form,
c) contacting said first liquid phase with copper ions, so as to obtain a second liquid phase,
d) contacting said second liquid phase with a carbonate and optionally a hydroxide, so as to obtain a third liquid phase, M3 in a solid form, optionally M4 in a solid form and optionally M2 in a solid form,
e) recovering said M3 in a solid form, optionally said M4 in a solid form, and optionally said M2 in a solid form,
said M2 in a solid form being recovered in step b) and/or step e),
M1 being selected from the group consisting of iron, aluminum, titanium, a rare earth, an actinide, and a combination thereof,
M2 being manganese, and
M3 and M4 being each independently selected from the group consisting of nickel, cobalt, and a combination thereof.

17. The process according to claim 16, wherein:
M1 is iron, aluminum, a rare earth chosen from lanthanum and praseodymium, or a combination thereof; and/or
M3 is nickel and M4 is cobalt.

18. The process according to claim 16, wherein:
M1 in a solid form is a carbonate, a hydroxide, an oxide, or a combination thereof, of M1;
M2 in a solid form is a carbonate, a hydroxide, an oxide, or a combination thereof, of M2;
M3 in a solid form is a carbonate, a hydroxide, an oxide, or a combination thereof, of M3; and/or
M4 in a solid form is a carbonate, a hydroxide, an oxide, or a combination thereof, of M4.

19. The process according to claim 16, wherein the at least one amine is selected from ethylene diamine, propane diamine, diethylenetriamine, triethylenetetramine, tris-(2-aminoethyl)amine, lysine, glycine, 2,3-diaminopropionic acid, 2,4-diaminobutyric acid, and 2,5-diaminopentanoic acid.

20. The process according to claim 16, wherein M2 in a solid form is recovered in step b).

21. The process according to claim 20, wherein:
step a) comprises contacting said liquid sample with at least one amine and optionally CO₂, so as to obtain a first liquid phase, M1 in a solid form, and M2 in a solid form, and
step b) comprises recovering successively said M1 in a solid form and said M2 in a solid form.

22. The process according to claim 20, wherein steps a)-b) comprise:
i) contacting the liquid sample with at least one amine, so as to obtain a liquid phase L0 and M1 in a solid form,
ii) recovering said M1 in a solid form,
iii) contacting said liquid phase L0 with CO₂ and optionally at least one amine, under an inert atmosphere, so as to obtain said first liquid phase and M2 in a solid form, and
iv) recovering M2 in a solid form.

23. The process according to claim 20, wherein steps a)-b) comprise:
i′) contacting the liquid sample with at least one amine and CO₂ under an inert atmosphere, so as to obtain a liquid phase L0′,
ii′) heating said liquid phase L0′ to a temperature T₁ above room temperature, under an inert atmosphere, so as to obtain a liquid phase L0″ and M1 in a solid form,
iii′) recovering said M1 in a solid form,
iv′) heating said liquid phase L0″ to a temperature T₂ above room temperature, under an oxygen-containing atmosphere, so as to obtain said first liquid phase and M2 in a solid form, and
v′) recovering M2 in a solid form.

24. The process according to claim 23, wherein the temperatures T₁ and T₂ are each independently comprised between 70° C. and 110° C.

25. The process according to claim 20, wherein steps d)-e) comprise:
α) contacting said second liquid phase with a carbonate and optionally a hydroxide, so as to obtain a liquid phase L1 and M3 in a solid form,
β) recovering said M3 in a solid form,
γ) contacting said liquid phase L1 with a reducing agent, so as to obtain the third liquid phase and M4 in a solid form, and
δ) recovering said M4 in a solid form.

26. The process according to claim 25, wherein said reducing agent is a solid metal.

27. The process according to claim 26, wherein the solid metal is metallic cobalt, metallic iron, or metallic copper.

28. The process according to claim 25, wherein the reducing agent is CO₂ or activated carbon.

29. The process according to claim 16, wherein M2 in a solid form and optionally M4 in a solid form are recovered in step e).

30. The process according to claim 29, wherein M2, M3 and optionally M4, each in a solid form, are recovered in the form of one single salt.

31. The process according to claim 30, wherein the single salt is a carbonate, a hydroxide or a combination thereof.

32. The process according to claim 16, wherein said liquid sample further comprises a chemical element M5, and said process further comprises, after step e), the following steps:
f) precipitating M5 in a solid form from the third liquid phase, so as to obtain M5 in a solid form and a fourth liquid phase, and
g) recovering M5 in a solid form by filtration, centrifugation, or reverse osmosis, wherein M5 is copper.

33. The process according to claim 16, further comprising before step a):
a step of leaching lithium from a solid sample comprising lithium, M1, M2, M3 and optionally M4, so as to obtain leached lithium and a solid sample comprising M1, M2, M3 and optionally M4;
a step of recovering said leached lithium; and
a step of converting said solid sample comprising M1, M2, M3 and optionally M4, into said liquid sample comprising M1, M2, M3 and optionally M4.

34. The process according to claim 16, wherein said liquid sample further comprises lithium and said process further comprises, after step e) or step g):
h) concentrating said third or fourth liquid phase, so as to obtain lithium in a solid form, and
j) recovering lithium in a solid form.

35. The process according to claim 34, wherein lithium is recovered by filtration, centrifugation, or reverse osmosis.
